(19) United States
(12) Patent Application Publication
(10) Pub. No.: US 2021/0004344 A1
(43) Pub. Date: Jan. 7, 2021

(54) Modular Polyhedral Computer Architectures and Network Optimization Algorithms

(71) Applicant: Jessica Cohen, Niagara Falls, NY (US)

(72) Inventor: Jessica Cohen, Niagara Falls, NY (US)

(73) Assignee: Lake of Bays Semiconductor Inc., Niagara Falls, NY (US)

(21) Appl. No.: 16/502,070

(22) Filed: Jul. 3, 2019

(51) Int. Cl. G06F 13/40; G06N 3/04

(52) U.S. Cl. CPC G06F 13/4027; G06N 3/0454

(57) ABSTRACT

A plurality of processors and routers are mounted on a scalable, modular, polyhedral cluster, creating a mixed hypercube-toroid network. The architecture scales in a lattice model. Therefore within each cluster, the routers are capable of routing messages in hypercube topologies of at least up to six dimensions, and continue by extension to the next cluster on the scaling lattice. Also described herein are various network routing paths derived from one topological embodiment, a cuboctahedron+centroid interconnect, which optimize network traffic for distributed computing, and shared memory applications. Also described herein are mechanical polyhedral scaffoldings for mounting and connecting processors or single board computers. The processor configurations enable function-follows-form computing. Their computing benefits include reduced latency in distributed computing applications, such as swarm movement; improved shared memory; and increased number of interconnects among neighboring nodes, which offers improved neural network computing.

### RELATED APPLICATIONS

The present invention incorporates all of the materials from the inventor's previous U.S. patent Ser. No. 16/429,032, “Polyhedral structures and network topologies for high performance computing”.

### Field of the Invention

The present invention relates to distributed computing, parallel computing, network architecture, compiler optimizations, routing algorithms, embedded systems, and mechanical linkages.

### SUMMARY

A plurality of processors and routers are mounted on a scalable, modular, polyhedral cluster, creating a mixed hypercube-toroid network. The architecture scales in a lattice model. Therefore within each cluster, the routers are capable of routing messages in hypercube topologies of at least up to six dimensions, and continue by extension to the next cluster on the scaling lattice. Also described herein are various network routing paths derived from one topological embodiment, a cuboctahedron+centroid interconnect, which optimize network traffic for distributed computing, and shared memory applications. Also described herein are mechanical polyhedral scaffoldings for mounting and connecting processors or single board computers. The processor configurations enable function-follows-form computing. Their computing benefits include reduced latency in distributed computing applications, such as swarm movement; improved shared memory; and increased number of interconnects among neighboring nodes, which offers improved neural network computing.

### BACKGROUND OF THE INVENTION

Many contemporary computing applications, such as image processing, object detection, and protein analysis, use neural nets. Neural nets' forms are fanning and contracting trees. Processors such as IBM True North and Intel Loihi provide algorithmic frameworks to support these neural nets but only on the software layer. The underlying hardware is rectilinear, due to manufacturing constraints and programming complexity.

Intel produced several supercomputers using hypercube design, notably the iPSC/860. Hypercube systems were eventually superseded by systems using 2-D mesh arrangements for their processors; the mesh arrangement allowed for greater scalability, as the iPSC/860 reached its threshold at 128 processors, lesser cost of expansion, and more generic usability.

What is needed is an architecture for virtually limitless scaling of processors and sharing of memory, and in particular, architecture which is suitable for distributed edge processing.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the spirit and scope of the invention to these particular embodiments. These drawings shall in no way limit any changes in form and detail that may be made to the invention by one skilled in the art without departing from the spirit and scope of the invention.

FIG. 1 shows an assembled cuboctahedral compute cluster, supporting 24 single board computers mounted on 6 square faces, and an additional processor node at its centroid node, as described in Claims 1, REF_Ref12134700 \r\h \* MERGEFORMAT 2, and REF_Ref12134257 \r\h \* MERGEFORMAT 4.

FIG. 2 shows the cuboctahedral cluster of Claims 1, REF_Ref12134700 \r\h \* MERGEFORMAT 2, and REF_Ref12134257 \r\h \* MERGEFORMAT 4, in its disassembled form, wherein groups of 4 rods form stackable trays as described in Claim REF_Ref12134878 \r\h \* MERGEFORMAT 7.

FIGS. 3, 4, and 5 are orthogonal views of a computer cluster as described in 1, REF _Ref12134700 \r\h \* MERGEFORMAT 2, and REF_Ref12134257 \r\h \* MERGEFORMAT 4, wherein one computer board assembly is mounted into each of the cuboctahedron's 6 square faces.

FIGS. 6, 7, 8, and 9 are orthogonal views of multiple computer clusters from FIG. 1 connected and stacked into an expanded computer cluster.

FIG. 10 shows one application of the first embodiment, wherein a plurality of compute clusters described in Claims 1, REF _Ref12134700 \r\h \* MERGEFORMAT 2, and REF _Ref12134257 \r\h \* MERGEFORMAT 4 installed in an aerodynamically shaped and cooled pod, which is suspended from an unmanned aircraft, whereby enabling edge computing applications such as streaming video processing or swarm guidance.

FIG. 11 shows another application of the first embodiment, wherein stacked racks of a disassembled computer cluster are stored and transported in a robotic mule, for the purpose of assembly in a remote field.

FIGS. 12 and 13 show an expanding spherical tensile structure frame onto which 6 square computer boards are mounted, whereby when the frame is contracted, the computer boards configure into a cube, and when the frame is expanded into a spherical shape, the frames open into a ventilate compute cluster. Neither the single board computer design nor the spherical tensile structure are claimed as part of this invention.

FIGS. 14, 15, 16, 17, 18, and 19 show orthogonal views of a doubly-nested cuboctahedral compute cluster with centroid node. This compute cluster enables data traffic routing patterns similar to a toroid coil or rodin coil.

FIGS. 19 and 20 are also views of a doubly-nested cuboctahedral compute cluster with centroid node, with indications of wireless communication patterns.

FIG. 21 is a compute cluster in the shape of a rhombic dodecahedron with a centroid node, as described in Claims 3 and 4.

FIG. 22 is a ‘system of systems’ compute cluster, wherein each peripheral node also contains a cuboctahedral compute cluster.

FIGS. 23 and 24 show message passing routes for neural networks enabled by the compute clusters described in Claims 1, REF _Ref12134700 \r\h \* MERGEFORMAT 2, and REF _Ref12134257 \r\h \* MERGEFORMAT 4.

FIG. 25 shows one embodiment of an expanded message passing interface derived from two stacked compute clusters.

FIG. 26 shows one embodiment of a toroid message passing interface derived from two doubly-nested cuboctahedral compute cluster.

FIGS. 27, 28, 29, 30, 31, and 32 show varied message passing interfaces for neural networks derived from polyhedral clusters which comprise a centroid node.

FIG. 33 shows a message passing interface among three processing nodes.

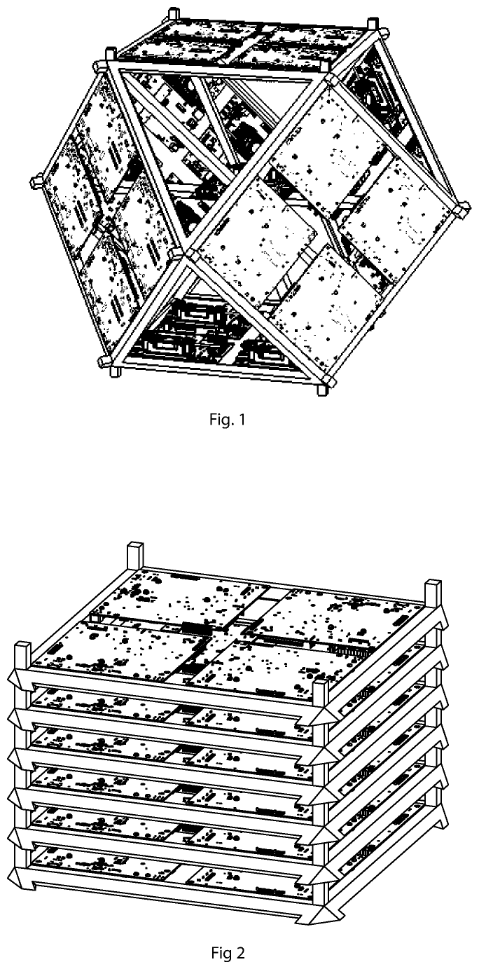

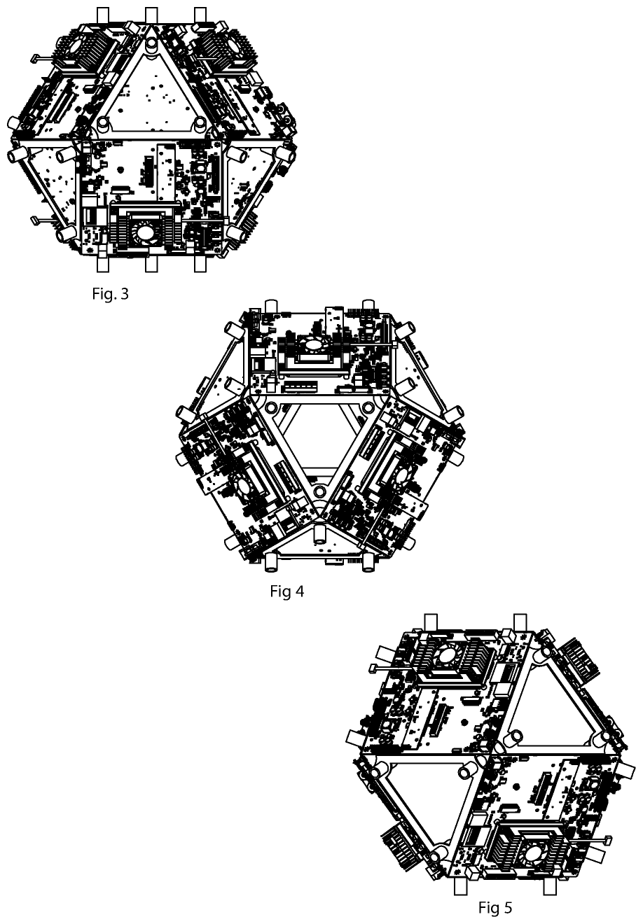

### DESCRIPTION OF EXAMPLE EMBODIMENTS

Described herein is a macro-scale configuration of a plurality of processors mounted on modular, scalable polyhedral cluster. The architecture is a form of a hybrid hypercube-toroid computer, and scales in a lattice model. Also described herein are various network routing paths derived from one topological embodiment, a cuboctahedron+centroid interconnect, which optimize network traffic for distributed computing, and shared memory applications. The present invention does not have a limit on the number of processors, in fact, becomes more powerful as more processors are added.

The processor configurations enable function-follows-form computing, with improvements for applications such as signal processing, distributed computing, peer-to-peer computing, neural nets, streaming video processing, and geospatial and magnetism calculations. Said computers' structural properties are applicable for edge computing, or mobile high-performance computing; and for heat-restricted and size-restricted applications such as cellphones.

Described herein are mechanical polyhedral scaffoldings for mounting and connecting processors or single board computers. Scaffolding rods form the edges of a polyhedral cluster, and additional rods connect the vertices to an internal centroid node, which acts as a structural reinforcement. Processors may be mounted on the faces or at the vertices of the cluster, and on the centroid node. An additional compute node is positioned at the center of the cluster to direct network traffic, manage memory, or perform other functions, which may act as a graph hub. Processors on the periphery of the cluster may act as slaves to the processor on the centroid node. The rods contain networking and power, and comprise clasps at their ends; the rods may also contain heating or cooling fluid. The scaffolding may be disassembled, wherein each face of the cuboctahedron becomes a stackable tray, for portability. Multiple clusters may be assembled, by means of connectors, into an exascale computer with shared memory.

The preferred embodiment shows a single board computer mounted onto each square face of a cuboctahedral scaffolding, and an additional processor at the center of the cluster. This cluster may be disassembled into 6 square racks for transport. A second embodiment shows a cuboctahedral cluster which contains multiple single board computers mounted with each square face. A third embodiment shows a doubly-nested cuboctahedron comprised of one centroid node and 24 vertices, which enables toroid networking traffic. A fourth embodiment shows a compute cluster with processors affixed at the vertices of a polyhedral cluster. A fifth embodiment shows a compute cluster in the shape of a rhombic dodecahedron, with one centroid node and 14 peripheral vertices. A sixth embodiment shows 6 single board computers affixed to the 6 vertices of a spherical tensile structure, wherein contracted form, the six boards form a cube.

Polyhedral configurations are generally accepted as optimal to rectilinear for software, however they are more complex to manufacture and program. Their computing benefits include reduced latency in distributed computing applications, such as swarm movement; improved shared memory; and increased number of interconnects among neighboring nodes, which offers improved neural network computing. The cuboctahedron is particularly suitable as a computing scaffolding, since it is comprised of hexagons, which is preferred for message passing over rectangles. As the cuboctahedron is essentially spherical, in that each peripheral node is equidistant from the centroid node, it is the ideal compute cluster form. The clusters are also stackable in a rectilinear grid. Polyhedral interconnects are also superior to conventional parallel chains. They offer better thermal management, suitability for extreme environments, stackability, and structural stability.

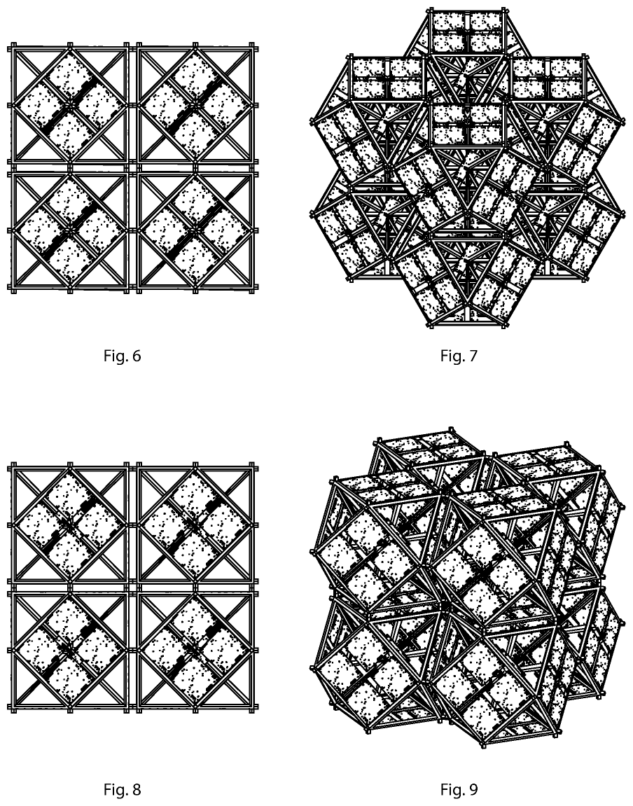

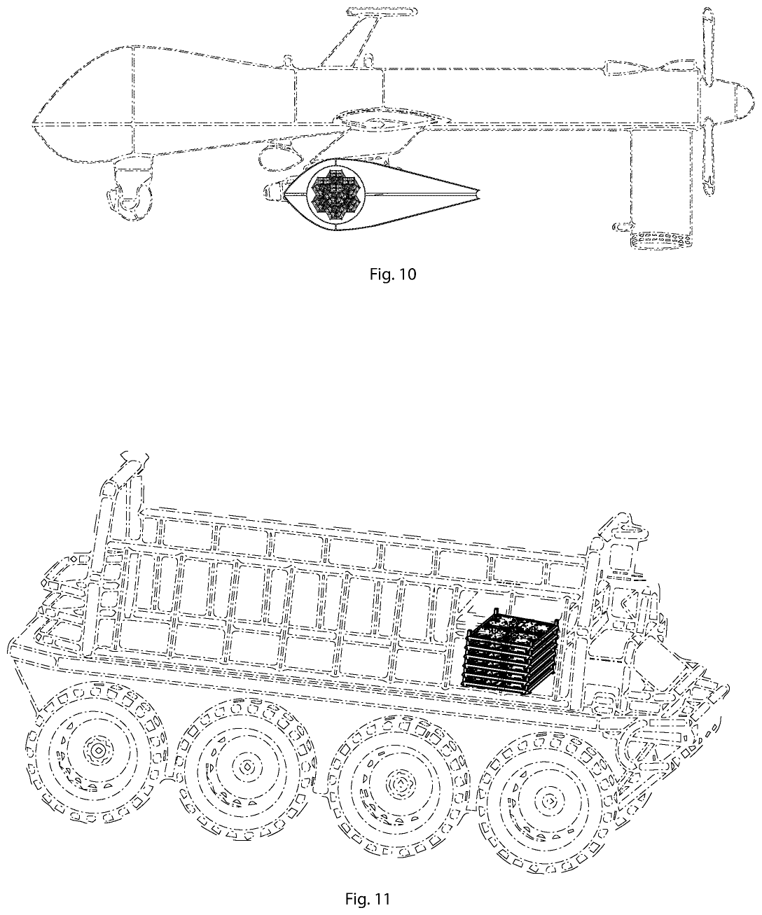

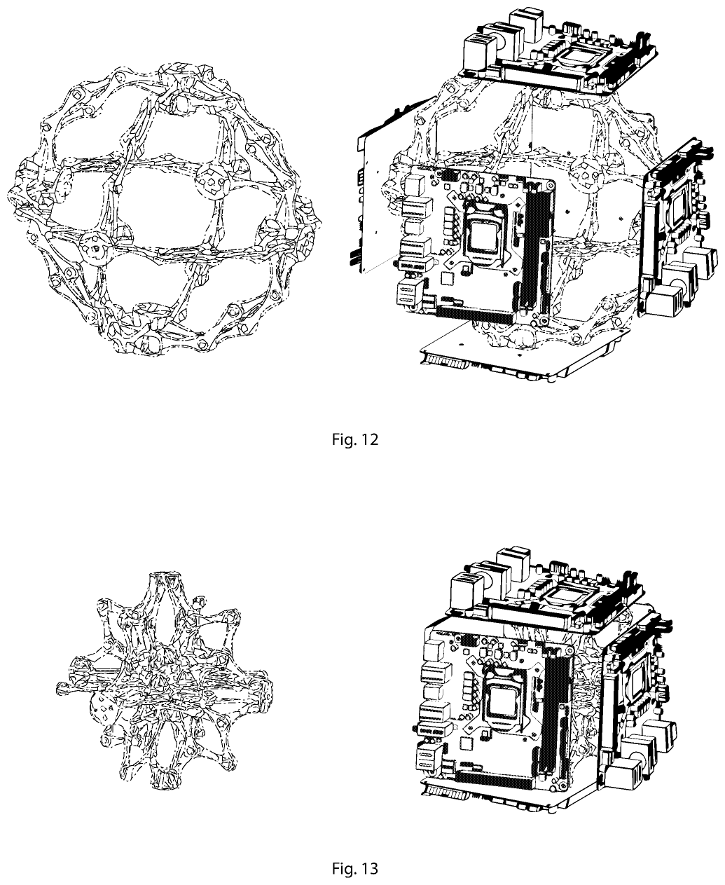

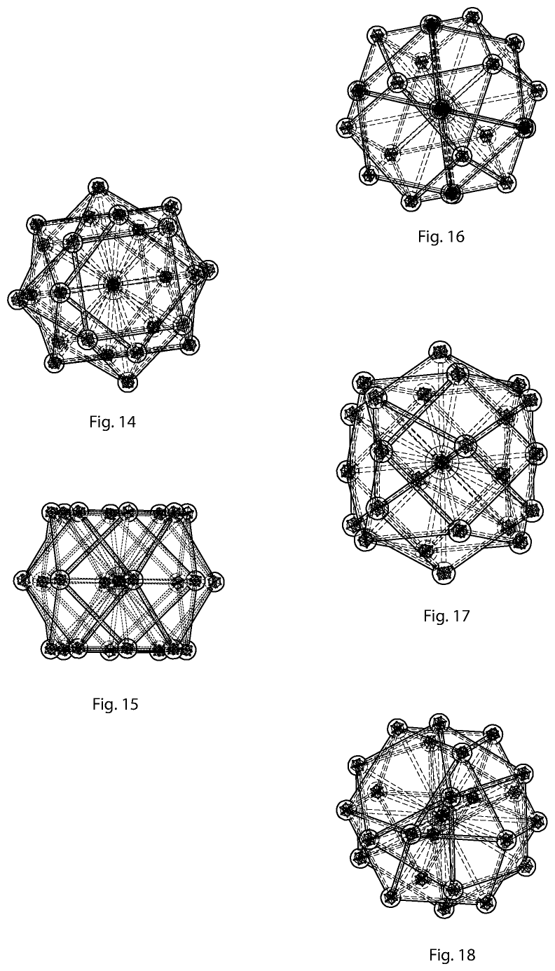

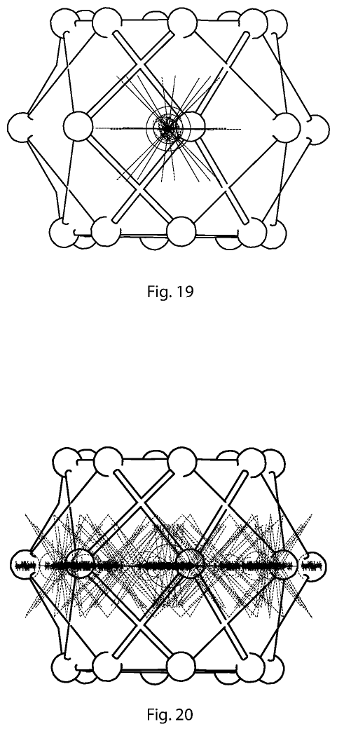

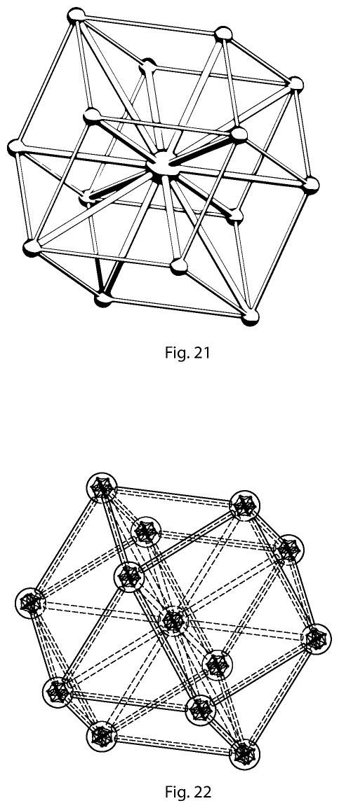

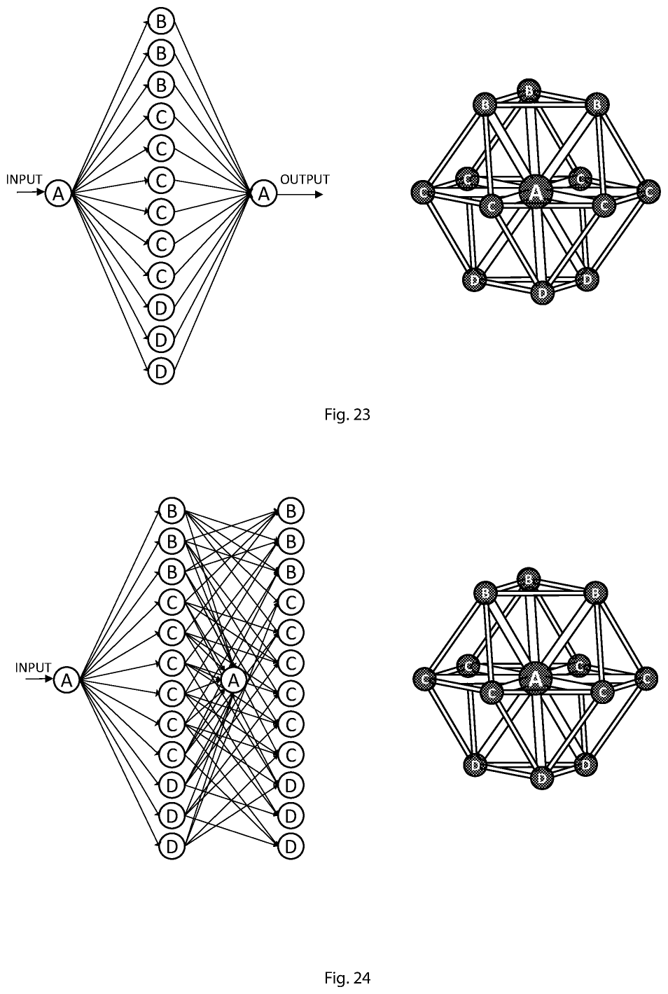

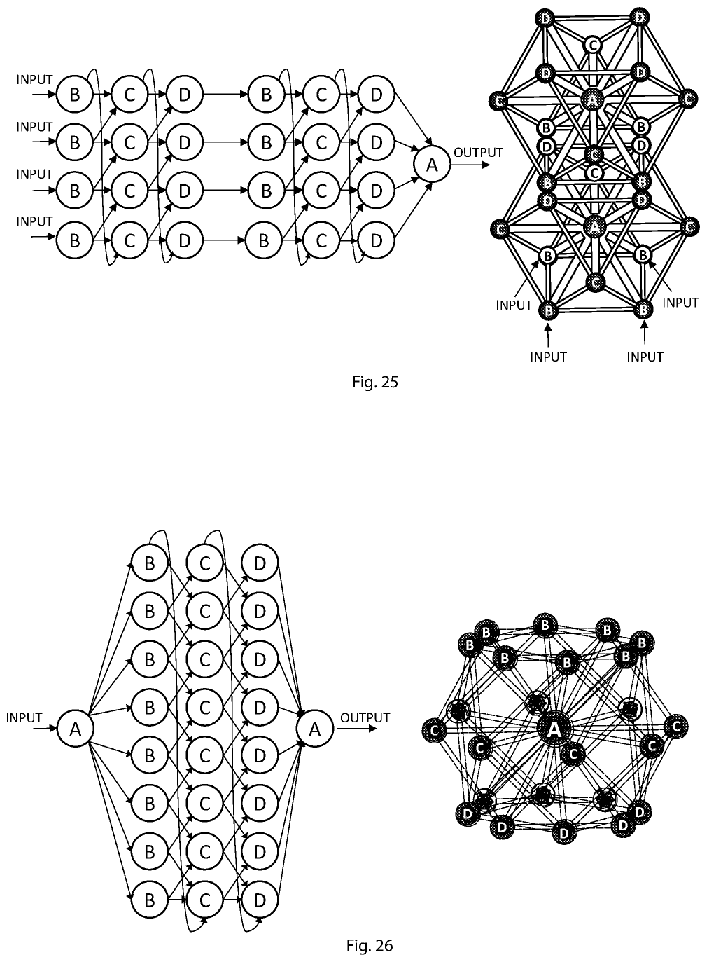

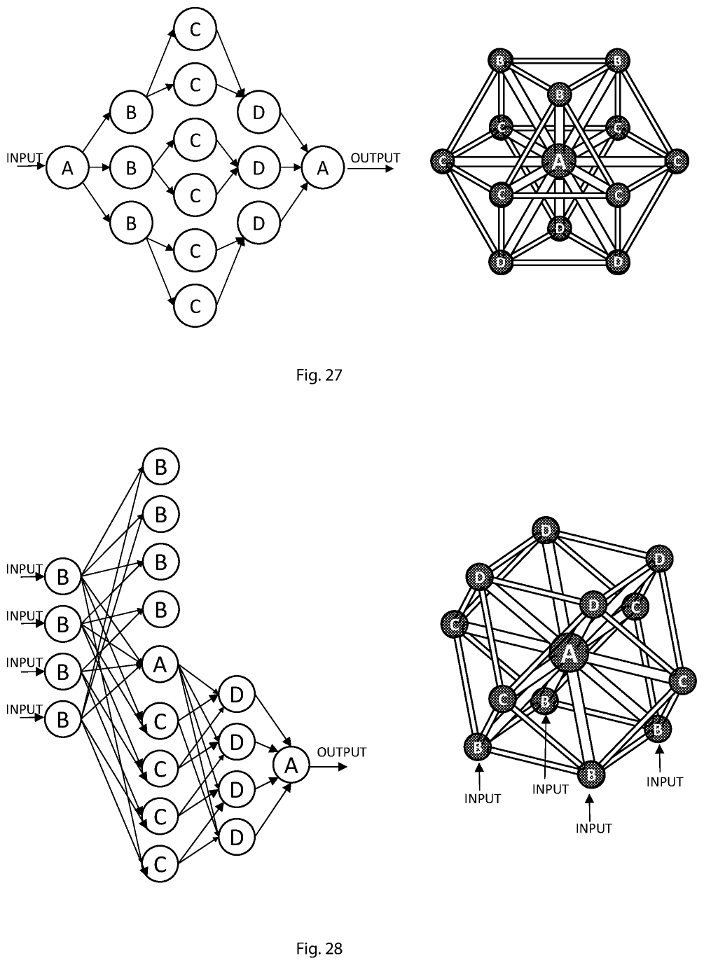

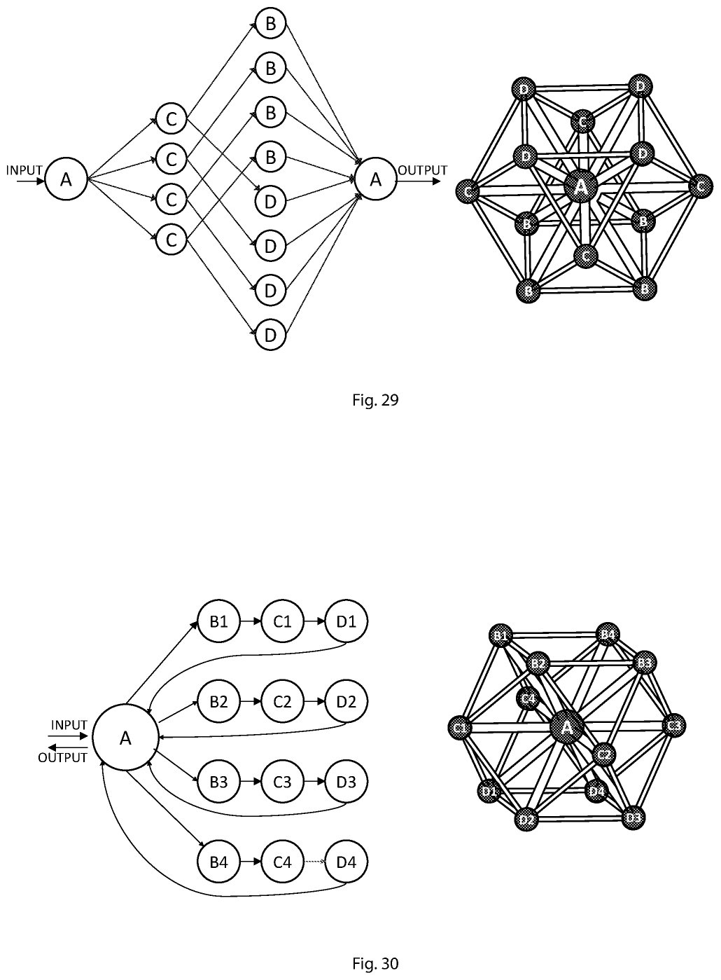

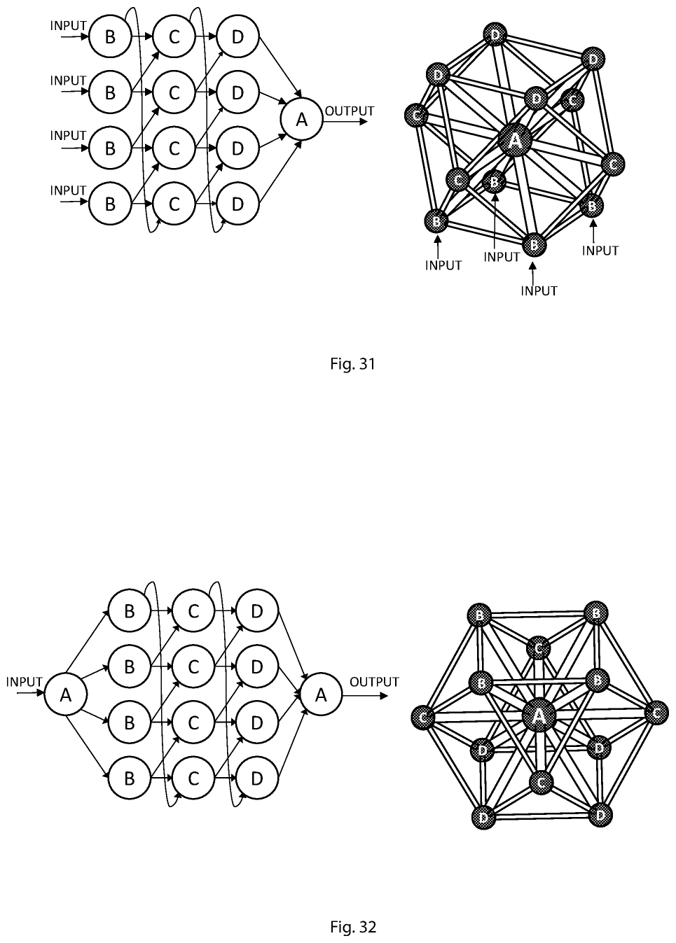

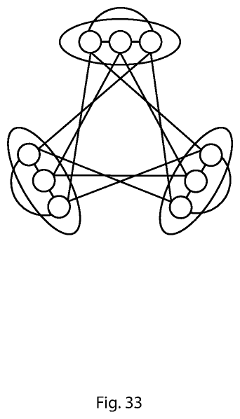

FIGS. 1, 6, 7, 8, and 9 show a cuboctahedral cluster with one compute node in the center, and 24 nodes dispersed equally on six external faces. The high-node connectivity and uniformity of this 25-node embodiment allow for easy implementation of 3D meshes and embedding a 4D hypercube. Clustering then creates six-dimensional meshes and allows higher-dimensional hypercubes to be embedded. This also enables the embedding of supercomputing topologies: 2D and 3D torii, and in particular, tree and fat tree topologies.

In the present embodiment, a single cuboctahedral cluster with 25 components comprises a 3D mesh. When multiple clusters are stacked, each individual node's position is 3D space becomes relative to the lattice. The clusters form a pattern of patterns, or 6D mesh.

A 4-D hypercube can be immediately embedded into a single cuboctahedron with a dilation of 2, wherein two clusters connect via two opposite square faces, and maintaining a uniform distance to the host. A single such unit can then be extrapolated to a cluster creating a 6D mesh of hypercubes. Higher dimensional hypercubes can be embedded, but beginning at 5 dimensions these require clusters of cuboctahedrons and the dilation gets larger. The inventor contemplates embedding 5D and 6D hypercubes in clusters.

Most parallel supercomputers are linear parallel configurations of multiple single board computers. Their thermal management is inherently poor by design, as each unit's heat becomes trapped in the thin space between the next unit, and effectively heats up its neighbor. By spacing single board computers in a three-dimensional, polyhedral form, the present configurations herein offer superior processing power with better thermal management, as each board disperses heat towards open space and not against its neighbor.

Messages pass more optimally along hexagonal grids than rectangular grids. Proposed herein is a macro-scale, hypercube computer, in a function-follows-form hardware configuration which offers neural net and distributed computing capabilities. The preferred embodiment is a modified cuboctahedron, which is at once spherical and rectilinear. It is spherical in that all peripheral nodes are equidistant to the centroid node. It is tree-like in that each node is connected equidistant to at least 4 neighbors. From certain perspectives the cuboctahedron is also square which makes it stackable in a compact grid.

Furthermore, networking among these boards is also limited by orthogonal interconnects in a linear hierarchy. Chaining more processors only increases the network's overall power by n=1, while the present embodiments increase by n=1.6 and higher. Neural net processing is improved by affording each node multiple times more connections with its neighbors.

The flexibility and uniformity of the cuboctahedral design is an advantage of the disclosed embodiments. Stacking clusters on their square edges can nearly emulate standard parallel constructions and produce high connectivity, as shown in the 25-node arrays of FIGS. 1, 6, 7, 8, and 9, while stacking on the triangle edges causes a slight expansion that allows trees and fat tree topologies to exist with uniform inter-node distance. Within each cuboctahedral, a uniform distance to the host also makes for good programming implementation.

The embodiments are particularly effective for tree patterns for neural networks. A single computer cluster may function as a tree, and lattices even more so. Stacking on edges causes a slight expansion and allows these networks to be expanded while maintaining uniform inter-node distance.

The present embodiments' advantages are the flexibility in the network design, its ability to be altered and scaled, the uniform treatment of the processing nodes, the ability for the clusters grow in a lattice and maintain uniform treatment of tree networks; and the centric placement of the host for coordinating the peripheral nodes. The extra space within the polyhedron can accommodate extra computer peripherals. The embodiments improve topological path length, uniformity, and node connectivity.

The main advantage of the hypercube is that its uniform placement of components, high node connectivity, and small diameter allow it to flexibly emulate many other network topologies. In the case of the 4-D hypercube there are 4 connections per node, 16 nodes, and the graph has a diameter of 5. With the cuboctahedral the figures are the same except that there are 24 nodes, plus one centroid node, for a total of 25.

The present embodiments improved topological path lengths and node connectivity ranks over prior hypercube-tree networks. Each node in a single cuboctahedral cluster may connect to 4 neighbors, plus one central node, for a total of 5 connections; this increases to 6 when the clusters connect. The cell matrix is essentially cubic with 4 nodes per face (and host at the center). In the embodiment of the 6 node this is star shaped. The centric placement of the host is ideal for algorithmic control. The varying stacking arrangements allow topological path lengths to be minimized while optimizing the structure of the network. While the preferred lattice shows cuboctahedral clusters connected at their square faces, the clusters may also connect by their triangular faces. As connection via the triangle edges spreads the structure, this also allows tree and fat tree arrangements to be grow indefinitely while maintaining a uniform inter-nodal distance.

Applications for the embodiments described herein include but are not limited to: statistical data management in a biomedical/clinical database, wherein the present invention acts as a lattice relational model, offering physical structures for extended relational operators, (lattice) NEST, (lattice) UNNEST, MERGE, SPREAD, and GEN, to reorganize relations; protein Structure modeling—the preferred lattice structure for modeling protein structures is the 3D face centered cube, which resembles the cuboctahedron (Amandeep et al); devices, such as cellphones, with high density, low defect tolerance, short interconnects and small overall form factors; convolutional loop optimization; and autonomous robotic motion of exploratory rovers, or guidance of swarms of unmanned autonomous vehicles, wherein the present invention offers reduced latency in communications among neighboring nodes.

### PRIOR ART: PATENT REFERENCES

| Title | Patent Number | Inventor/s | Filing Date |
|---|---|---|---|
| Hierarchical fat hypercube architecture for parallel | U.S. Pat. No. 5,669,008A | Galles et al | May 5, 1995 |
| processing systems | | | |
| Microelectronic integrated circuit structure and | U.S. Pat. No. 005,578,840A | Scepanovic et al. | Nov. 26, 1996 |
| method using three directional interconnect | | | |
| routing based on hexagonal geometry | | | |
| Polyhedral IC package for making three | U.S. Pat. No. 6,008,530A | Ryuichi Kano | May 29, 1997 |
| dimensionally expandable assemblies | | | |
| Hybrid hypercube/torus architecture | U.S. Pat. No. 6,230,252B1 | Passint et al. | Nov. 17, 1997 |
| Tri-directional interconnect architecture for sram | U.S. Pat. No. 5,889,329 | Rostoker et al. | Mar. 30, 1999 |
| Modular array computer with optical intercell | U.S. Pat. No. 7,519,245B2 | Kirk M. | Oct. 31, 2006 |
| communications pathways | | Bresniker | |
| Non-orthogonal structures and space tiles for | U.S. Pat. No. 7,516,433 | Pucci et al | Apr. 7, 2009 |
| layout, placement, and routing of an integrated | | | |
| circuit | | | |
| Network interface controller for virtual and | EP2619676A1 | Galles et al | Sep. 23, 2010 |
| distributed services | | | |
| Scalable electronics, computer, router, process | US20120147558A1 | Richard Anthony | Dec. 9, 2010 |
| control and other module/enclosures employing | | Dunn, J R. | |
| approximated tesselation(s)/tiling(s) or electronics | | | |
| and other modules from tow modules to columns, | | | |
| rows and arrays with optional deployment utilizing | | | |
| palletization for build out of existing industrial | | | |
| space and/or new construction with nestable | | | |
| wiring applicable from module and assembly level | | | |
| to molecular and atomic levels | | | |
| System and methods for scalable parallel data | U.S. Pat. No. 9,220,180B2 | Richard Anthony | Dec. 9, 2010 |
| processing and process control | | Dunn | |
| Datacenter with angled hot aisle venting | U.S. Pat. No. 8,867,204B1 | Brock R. | Aug. 29, 2012 |
| | | Gardner | |
| Alternative data center building designs | U.S. Pat. No. 9,167,724B1 | Christopher | Nov. 21, 2012 |
| | | Gregory Malone | |
| Symmetrical hexagonal-based ball grid array | US20140153172A1 | Gary Brist | Dec. 5, 2012 |
| pattern. | | | |
| Advanced Datacenter Designs | US20140185225A1 | Joel Wineland | Dec. 28, 2012 |
| Systems and methods for controlling multi-level | U.S. Pat. No. 9,912,251B2 | Subrata K | Oct. 21, 2014 |
| diode-clamped inverters using space vector pulse | | Mondal | |
| width modulation (SVPWM). | | | |
| Rack for computing equipment | WO2016145049A1 | Colton Malone | Mar. 9, 2015 |

### PRIOR ART: NON-PATENT REFERENCES

Agarwal, Annanay. “Enable Polyhedral Optimizations in XLA through LLVM/Polly.” Polly Labs. 2018. https://pollylabs.org/gsoc2017/Enable-Polyhedral-Optimizations-in-XLA-through-LLVM-Polly.html

Bastoul, Cedric et al. “Putting Polyhedral Loop Transformations to Work.” Lecture Notes in Computer Science. Oct. 1, 2003. DOI: 10.1007/978-3-540-24644-2_14

Blinder, Pablo et al. “Functional Topology Classification of Biological Computing Networks.” Natural Computing 4(4):339-361. Sep. 1, 2005. https://www.researchgate.net/publication/226482709_Functional_Topology_Classification_of_Biologic al_Computing_Networks

Boyle. “HPE Powers New Tesseract Supercomputer at EPCC.” Oct. 8, 2018. https://insidehpc.com/2018/10/hpe-powers-new-tesseract-supercomputer-epcc/

Denzel. “A Framework for End-to-end Simulation of High Performance Computing Systems”. ICST (Institute for Computer Sciences, Social-Informatics and Telecommunications Engineering) ICST, Brussels, Belgium, Belgium ©2008, ISBN: 978-963-9799-20-2. Mar. 3-7, 2008.

Emer, Joel. “Hardware Architectures for Deep Neural Networks.” ISCA Tutorial. Jun. 24, 2017. http://eyeriss.mit.edu/tutorial.html

Feautrier. “Polyhedron Model.” Encyclopedia of Parallel Computing (pp.1581-1592). Sep. 1, 2011. https://www.researchgate.net/publication/233401207_Polyhedron_Model

Fuller, Buckminster. “Buckminster Fuller Explains Vector Equilibrium.” https://www.youtube.com/watch?v=jcq_Hzo8PC8

Gila, Joseph et al. “Alternative Mapping of 3-D Space onto Processor Arrays.” Journal of Parallel and Distributed Computing, Volume 59, Issue 3, Pages 360-380, Dec. 1, 1999. https://doi.org/10.1006/jpdc.1999.1585

Kjos-Hanssen, Bjørn. “Superposition as memory: unlocking quantum automatic complexity.” arXiv:1703.04878v1. 7/8/2018. https://arxiv.org/pdf/1703.04878.pdf

Kloss. “Intel Nervana™ Neural Network Processor: Architecture Update.” Dec. 6, 2017. https://ai.intel.com/intel-nervana-neural-network-processors-nnp-redefine-ai-silicon/

Madappuram. “On brain-inspired connectivity and hybrid network topologies.” Nanoscale Architectures, 2008. NANOARCH 2008. IEEE International Symposium on 12-13 Jun. 2008. Date Added to IEEE Xplore: 1 Aug. 2008. DOI: 10.1109/NANOARCH.2008.4585792. Aug. 1, 2008.

Pandey, Shivendra et al. “Assembly of a 3D Cellular Computer Using Folded E-Blocks.” Micromachines 2016, 7(5), 78; Apr. 28, 2016. https://doi.org/10.3390/mi7050078

Ramos Alexandre F. et al. “Symmetry-guided design of topologies for supercomputer networks.” 28 Jun. 2017. arXiv.org. https://arxiv.org/abs/1706.09506; arXiv:1706.09506

Sidhu, Amandeep et al. “Biomedical Data and Applications”, p335. Studies in Computational Intelligence 224. Jul. 1, 1905. https://www.springer.com/gp/book/9783642021923

Sou, Kin Cheong. “On the Exact Solution to a Smart Grid Cyber-Security Analysis Problem.” arXiv:1201.5019v2. Sep. 17, 2012. https://arxiv.org/pdf/1201.5019.pdf

Teikari PhD, Petteri. “Geometric Deep Learning.” slideshare.net. Aug. 29, 2017. https://www.slideshare.net/PetteriTeikariPhD/geometric-deep-learning

Truszkowski, Walt. “Autonomous and Autonomic Systems: With Applications to NASA Intelligent Spacecraft Operations and Exploration Systems.” Springer, —Technology & Engineering, p 212, ISBN 978-1-84628-233-1. Nov. 12, 2009. https://www.springer.com/gp/book/9781846282324

Verdoolaege S. “Polyhedral Process Networks. Handbook of Signal Processing Systems.” Springer, Boston, Mass. 2010.

Weisstein, Eric W. “Cuboctahedron.” MathWorld—A Wolfram Web Resource. http://mathworld.wolfram.com/Cuboctahedron.html

Yang, Xuan et al. “A Systematic Approach to Blocking Convolutional Neural Networks.” arXiv:1606.04209v1 [cs.DC]. Jun. 14, 2016. https://arxiv.org/pdf/1606.04209.pdf

Yao, Yamashita. “Extended relational operators for statistical data manipulations in medical databases.” Comput Biomed Res. Dec. 1, 1989. 22(6):516-31; https://www.ncbi.nlm.nih.gov/pubmed/2591206

Zhai. “Modeling adaptive streaming applications with Parameterized Polyhedral Process Networks.” 48th Design Automation Conference, DAC 2011, San Diego, Calif., USA, Jun. 5-10, 2011. Jun. 5-10, 2011. https://www.researchgate.net/publication/221060943_Modeling_adaptive_streaming_applications_with_Parameterized_Polyhedral_Process_Networks

“Hypercube internetwork topology.” Wikipedia. Dec. 23, 2017. https://en.wikipedia.org/wiki/Hypercube_internetwork_topology

We claim:

1. A scalable network communication mesh comprised of stacked repeating rectangular grids of compute nodes, wherein each compute node is connected to all of its nearest neighbors along the x, y, and z axes by means of orthogonal connectors, and also connected to all of its nearest neighbors in the x-y, x-z, and y-z directions by means of non-orthogonal connectors, whereby creating greater bisection bandwidth than 6D mesh networks, and enabling greater parallel processes.

2. A scalable multi-processor network communication mesh in which each node connects to every neighboring node via orthogonal and non-orthogonal interconnects, designed as a polyhedral scaffolding frame, wherein said frame is comprised of:
rods, which correspond to said polyhedron's peripheral edges, creating vertices,
connector clips, affixed to the ends, and along the length, of the rods,
computer infrastructure peripherals, including power supply, and routers,
one or more single board computers containing processing, memory, and communication ports,
wherein the single board computers may be affixed to the rods, covering the flat faces of said polyhedron, and communicate with each other by means of said communication ports and protocols, forming a compute cluster,
wherein a plurality of clusters may be connected, by means of electromechanical fasteners, in a lattice configuration, to form a scalable network;
whereby enabling polyhedral message passing interfaces; distributed computing among the processors; shared memory among the memory units which grows as the network grows; a greater number of interconnects among neighboring processors than if assembled in a parallel stack or row; more efficient message passing at oblique angles; and passive cooling through the open spaces among the boards.

3. The polyhedral compute cluster of claim 2 which is further defined as a cuboctahedral frame, wherein comprising 6 flat faces, and one or more single board computers may be mounted on said square faces; multiple cuboctahedral clusters may be connected, either along their triangular faces, or along their square faces, by means of routers, to form a scaling network.

4. The polyhedral compute cluster of claim 2 which is further defined as a cuboctahedral frame, and a plurality of single board computers may be mounted on each of the polyhedron's vertices; multiple cuboctahedral clusters may be connected, either along their triangular faces, or along their square faces, to form a scaling network.

5. The polyhedral compute cluster of claim 2 which is further defined as a rhombic dodecahedral frame, wherein comprising 14 flat faces.

6. The polyhedral compute cluster of claim 2 which further comprises a centroid compute node positioned at the center of the cluster, and additional rods physically connecting said centroid to each peripheral vertex, and additional networking hardware which connects said centroid processor to each peripheral processor, wherein the centroid node supports an additional computer processor, which may act as a network hub, a traffic management node, or querying agent for multiple parallel databases, and also comprises message passing interfaces.

7. The polyhedral compute cluster of claim 2 wherein the structure may be disassembled into stackable modular rectilinear frames, corresponding to the edges of the single board computers, and flat-packed for transport.

8. The polyhedral compute clusters of claim 2 which are installed in an unmanned aerial vehicle, enabling high performance edge computing in a low-bandwidth and low-power environment.

9. Polyhedral message passing interfaces derived from the compute cluster of claim 2, wherein signals may be input at any node or nodes, pass to any neighboring node or plurality of neighboring nodes, and to nodes in neighboring clusters, in orthogonal and non-orthogonal patterns, whereby creating message passing interfaces including but not limited to toroid coils and neural net trees.

10. The compute cluster of claim 2 wherein the frame is further defined as an expanding and contracting tensile frame, which is substantially spherical when expanded, wherein 6 square single board computers are affixed on said frame's vertices, whereby when said frame is in contracted state, the six boards form a cube, for easier storage and transport.
